(19) United States
(12) Patent Application Publication
(10) Pub. No.: US 2024/0015047 A1
(43) Pub. Date: Jan. 11, 2024

(54) TRAVELING OBJECT, INFORMATION PROCESSING APPARATUS, INFORMATION PROCESSING METHOD, AND PROGRAM

(71) Applicant: NIPPON TELEGRAPH AND TELEPHONE CORPORATION, Tokyo (JP)

(72) Inventors: Yasushi OKANO, Tokyo (JP); Masashi TANAKA, Tokyo (JP); Takuma KOYAMA, Tokyo (JP); Masaru MATSUBAYASHI, Tokyo (JP)

(21) Appl. No.: 18/254,460

(22) PCT Filed: Dec. 9, 2020
(86) PCT No.: PCT/JP2020/045899

§ 371 Date: May 25, 2023

(51) Int. Cl. H04L 12/40

(52) U.S. Cl. CPC H04L 12/40032; H04L 2012/40273; H04L 2012/40215

(57) ABSTRACT

A mobile body including an apparatus and an information processing device, wherein the information processing device includes an acquisition unit that acquires a first signal and a second signal that are transmitted from the apparatus; and a determination unit that determines a relevance between the first signal and the second signal on the basis of a first spectrum of a frequency component of the first signal and a second spectrum of a frequency component of the second signal.

### TECHNICAL FIELD

The present invention relates to a mobile body, an information processing device, an information processing method, and a program.

### BACKGROUND ART

Conventionally, vehicles (automobiles, special vehicles, motorcycles, bicycles, etc.), machine tools, construction machinery, agricultural machinery, and other machinery are often equipped with a plurality of electronic control units (ECUs). A typical one used as a communication network between ECUs is a controller area network (CAN).

Communication data (message) between the ECUs on the CAN includes an ID and a payload. The ID is used for identifying the priority order of communication arbitration, the data content, the transmission node, and the like. The payload is loaded with data of 8 bytes at the maximum, and the data includes one or more signal values.

In the case of a vehicle as an example, the signals include those related to statuses and control of a speed, a lateral speed, an accelerator, a brake, an acceleration, steering angle, and the like. The assignment of these signals to the payload (bit assignment) is specifically determined by the manufacturer of the ECU. The communication related to an important function is designed to be transmitted periodically or in accordance with the period, and the interval of the communication of the ID related to said function is almost constant or similar to the design value.

In recent years, the risk of cyber attack on these machine control information communication networks has been suggested. For example, it is known that transmission data for attack of an ID related to an attack target function can be inserted by means of unauthorized connection of an ECU to a network or unauthorized operation rewriting to an existing ECU, and that unauthorized operation of the target function can be induced.

Various methods have been studied for detecting an attack on the CAN. On the other hand, as an important purpose of cyber attack analysis to be performed after detection, the impact and attacker intention are estimated. When the information of the bit assignment is used, the function affected by the attacked ID can be easily specified, and the influence function can be an important clue of attack intention estimation. However, the bit assignment information is generally uniquely determined and concealed by the ECU manufacturer, and the information cannot be easily obtained in cyber attack analysis.

For this reason, various methods for estimating bit assignment have been studied. The bit assignment estimation is often a two-step process that estimates the syntax (syntax estimation), such as which part of the payload is the signal region and whether the signal region is continuous-valued (e.g., speed) or binary-valued (e.g., door open/close), and then estimates the meaning (semantic estimation), such as which function the signal corresponds to.

NPLs 1 and 2 handle semantic estimation, and a method has been proposed in which a signal value whose function has been already identified is acquired by using a diagnostic function or the like, and the function of an unidentified CAN signal is estimated based on the function-identified signal. A method of estimating the function of an unidentified CAN signal by associating a target unidentified CAN signal with a function-identified signal that is close in similarity (distance) to the target unidentified CAN signal is proposed in NPL 1. NPL 2 proposes a method of machine-learning with a function as a classification name for a function-identified signal, and classifying and inferring the function of the unidentified CAN signal based on the learned model.

### CITATION LIST

### Non Patent Literature

[NPL 1] M. Verma, R. Bridges, and S. Hollifield, “ACTT: automotive CAN tokenization and translation,” in Proceedings of the International Conference on Computational Science and Computational Intelligence (CSCI), December 2018.
[NPL 2] C. Young, J. Svoboda, J. Zambreno, “Towards Reverse Engineering Controller Area Network Messages Using Machine Learning”, Proceedings of the IEEE World Forum on Internet of Things (WF-IoT), 2020.

### SUMMARY OF INVENTION

### Technical Problem

However, in the conventional semantic estimation, it is sometimes difficult to estimate a corresponding function for a CAN signal from which a corresponding function-identified signal cannot be obtained. For example, when only a signal which is found to be a speed display function is obtained, it is difficult to estimate the function of the CAN signal of the acceleration sensor function.

In one aspect, an object is to provide a technique capable of estimating a function targeted by a signal.

### Solution to Problem

In one scheme, a mobile body includes an apparatus and an information processing device, wherein the information processing device includes an acquisition unit that acquires a first signal and a second signal that are transmitted from the apparatus; and a determination unit that determines a relevance between the first signal and the second signal on the basis of a first spectrum of a frequency component of the first signal and a second spectrum of a frequency component of the second signal.

### Advantageous Effects of Invention

According to one aspect, a function targeted by a signal can be estimated.

### BRIEF DESCRIPTION OF DRAWINGS

FIG. 1 is a diagram for explaining a configuration of a communication system according to an embodiment.

FIG. 2 is a diagram for explaining an example of a hardware configuration of an information processing device according to an embodiment.

FIG. 3 is a diagram showing an example of a configuration of the information processing device according to an embodiment.

FIG. 4 is a flowchart for explaining an example of processing of the information processing device according to an embodiment.

FIG. 5 is a flowchart for explaining an example of processing of the information processing device according to an embodiment.

FIG. 6 is a flowchart for explaining an example of processing of the information processing device according to an embodiment.

FIG. 7 is a diagram showing an example of information indicating a syntax of bit assignment of CAN communication according to an embodiment.

### DESCRIPTION OF EMBODIMENTS

Embodiments of the present disclosure will be described below with reference to the drawings.

<Overall Configuration>

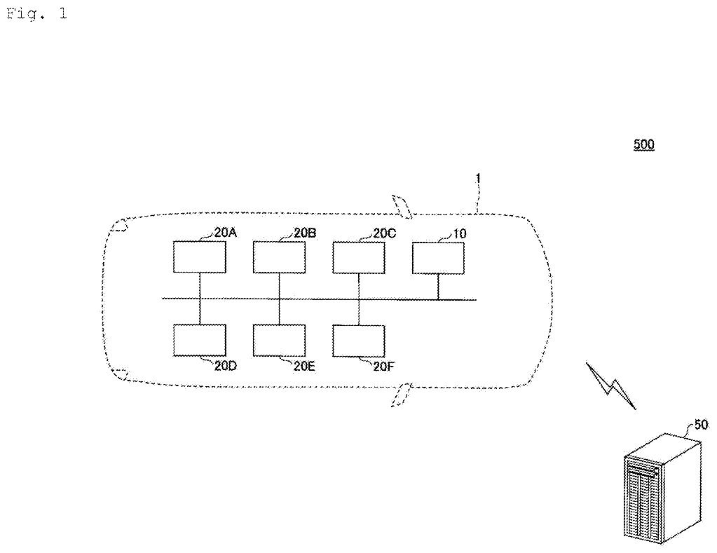

FIG. 1 is a diagram for explaining a configuration of a communication system 500 according to an embodiment. In the example shown in FIG. 1, the communication system 500 includes a mobile body 1 and a server 50. The mobile body 1 and the server 50 communicate with each other via a network N such as a mobile phone network such as 5G (5th Generation, fifth generation mobile communication system), 4G, LTE (Long Term Evolution), and 3G, a wireless LAN (Local Area Network), and the Internet.

The mobile body 1 may be for example, a vehicle (an automobile, a special vehicle, a motorcycle, a bicycle, etc.), or a machine such as a machine tool, a construction machine, and an agricultural machine. The mobile body 1 includes (is equipped with) an information processing device 10 and ECUs (Electronic Control Unit) 20A to F. Hereinafter, when no distinction is necessary, the ECU 20A to F are simply referred to as “ECU 20.” It should be noted that ECU 200 is an example of the “apparatus.”

The information processing device 10 and each ECU 20 communicate data by means of an internal communication network of the mobile body 1, such as a controller area network (CAN). Although an example in which the CAN is used as the internal communication network of the mobile body 1 will be described below, the internal communication network of the mobile body 1 is not limited to the CAN, and various networks such as LAN (Local Area Network) can be used.

<Hardware Configuration of Information Processing Device 10>

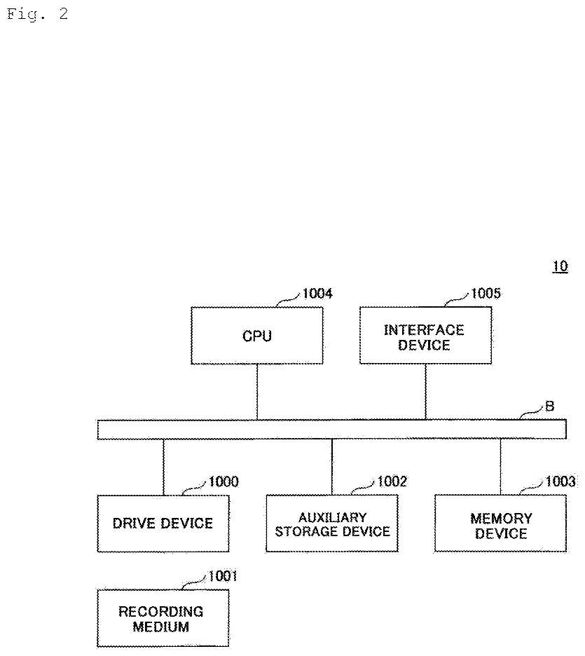

FIG. 2 is a diagram for explaining an example of a hardware configuration of the information processing device 10 according to the embodiment. In the example shown in FIG. 2, the information processing device 10 includes a drive device 1000, an auxiliary storage device 1002, a memory device 1003, a CPU 1004, an interface device 1005, and the like, which are connected to each other via a bus B.

An information processing program that implements processing in the information processing device 10 may be provided by a recoding medium 1001. In this case, when the recording medium 1001 in which the information processing program is recorded is set in the drive device 1000, the information processing program is installed onto the auxiliary storage device 1002 from the recording medium 1001 via the drive device 1000. However, the information processing program does not necessarily have to be installed from the recording medium 1001, and may be downloaded from another computer via the network. The auxiliary storage device 1002 stores necessary files, data, and so forth, as well as storing the installed information processing program.

The memory device 1003 reads and stores the program from the auxiliary storage device 1002 when there is an instruction to start the program. The CPU 104 executes processing according to the program stored in the memory device 1003. The interface device 1005 is used as an interface to connect to the network.

Examples of the recording medium 1001 include a portable recording medium such as a CD-ROM, a DVD disk, a USB memory, and the like. Examples of the auxiliary storage device 1002 include an HDD (Hard Disk Drive), a flash memory, and the like. Both the recording medium 1001 and the auxiliary storage device 1002 correspond to a computer-readable recording medium.

The information processing device 10 may also be implemented in integrated circuits such as ASICs (Application Specific Integrated Circuits) and FPGAs (Field-Programmable Gate Arrays).

<Configuration of Information Processing Device 10>

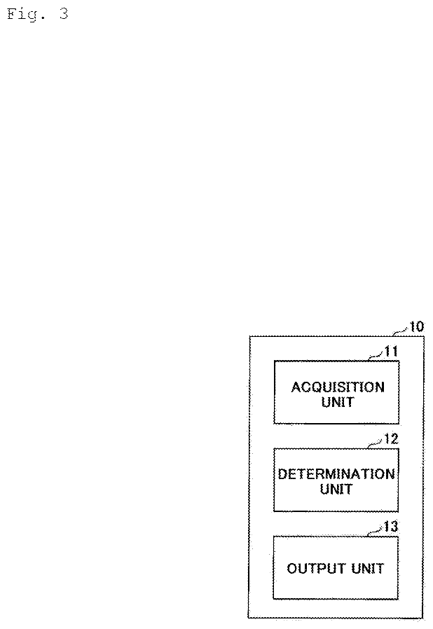

Next, a configuration of the information processing device 10 will be described with reference to FIG. 3. FIG. 3 is a diagram showing an example of a configuration of the information processing device 10 according to an embodiment.

The information processing device 10 includes an acquisition unit 11, a determination unit 12, and an output unit 13. These units may be realized through cooperation of one or more programs installed in the information processing device 10 with hardware such as the CPU 1004 of the information processing device 10.

The acquisition unit 11 acquires various types of information. The acquisition unit 11 acquires (samples) a signal (electric signal) from a CAN communication message transmitted from an ECU 20, for example.

The determination unit 12 performs various types of determination on the basis of each signal acquired by the acquisition unit 11. The determination unit 12 estimates a meaning (semantic estimation) that each signal acquired by the acquisition unit 11 corresponds to which function, for example. The output unit 13 outputs various types of information. The output unit 13 outputs information based on a determination result obtained by the determination unit 12.

<Processing>

<<Example of Using Correlation Analysis Between Two Signals>>

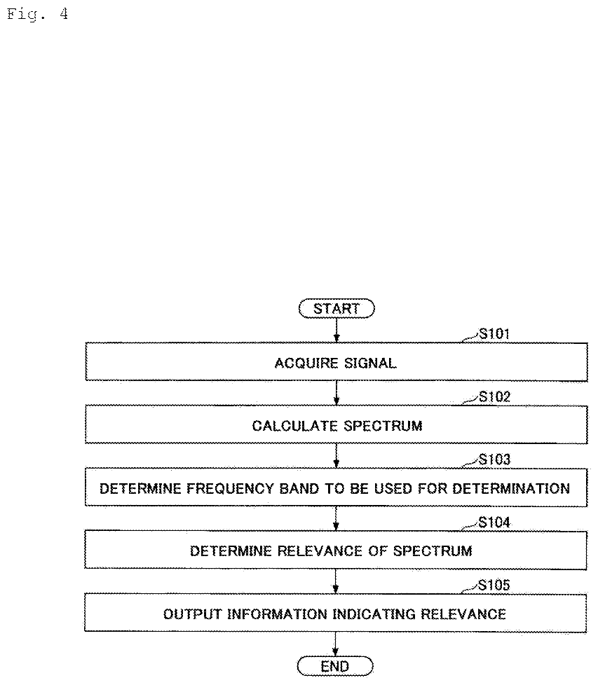

An example of processing of the information processing device 10 according to an embodiment will be described next with reference to FIG. 4. FIG. 4 is a flowchart for explaining an example of processing of the information processing device 10 according to an embodiment.

In step S101, the acquisition unit 11 acquires a first signal whose function is already identified and a second signal whose function is not identified. Here, the acquisition unit 11 acquires, for example, a signal (electric signal) from a communication message extracted from CAN communication, a signal obtained by a diagnostic function, and time series data obtained by digitally sampling an analogue signal or the like obtained from another measuring instrument (e.g., an external speed measuring instrument) under a predetermined quantization condition, as the first signal or the second signal. In this case, the acquisition unit 11 may set the recording time (lengths) of the respective signals to be equal. The quantization condition includes, for example, a sampling frequency (or a sampling interval) of a signal, the number of digital bits, and the like.

Subsequently, the determination unit 12 calculates a first spectrum of a frequency component of the function-identified first signal and a second spectrum of a frequency component of the function-unidentified second signal, which are acquired by the acquisition unit 11 (step S102). Here, the acquisition unit 11 acquires, for example, a signal (message) extracted from CAN communication, a signal obtained by a diagnosis function, time series data obtained by digitally sampling a signal or the like obtained from another measuring instrument (e.g., an external speed measuring instrument) under a prescribed quantization condition, as the first signal or the second signal. In this case, the determination unit 12 may set the recording time (lengths) of the respective signals to be equal. The quantization condition includes, for example, a sampling frequency (or a sampling interval) of a signal, the number of digital bits, and the like.

Then, the determination unit 12 uses, for example, discrete Fourier transform (DFT, Discrete Fourier Transform), Fast Fourier Transform (FFT), to convert the spectrum of a frequency component. The spectrum is information indicating intensity distribution obtained by decomposing the intensity of the signal for each frequency component included in the signal, for example. Since the spectrum is obtained by discretization of the frequency, the spectrum needs to be converted so as to match the frequency interval, and needs to be dealt with depending on the algorithm. In general discrete transform algorithms such as DFT, if the recording time of each signal is equal, the frequency intervals are equal, and therefore, there is no need to deal with the discrete transform algorithms. If it is necessary to deal with the signal, the determination unit 12 may perform a process of reassigning (re-sampling processing) the signal to the same sampling frequency by complementing the data before the conversion. When a signal not suitable for Fourier transform is included such as the mismatch between the initial value and the final value, the determination unit 12 may perform overlap processing, pre-processing such as window function processing. Further, the determination unit 12 may add pre-processing of difference conversion to a signal that monotonously increases or decreases such as a travel distance.

Subsequently, the determination unit 12 determines, from each signal, a spectrum of each signal, and a quantization condition that is information on a sampling frequency and the number of bits of the signal, and determines a frequency band in which the influence of quantization noise which hinders estimation of the relationship between the first signal and the second signal is small (step S103).

Here, it is preferable to determine the quantization noise by sampling the signal in consideration of the quantization noise. In particular, it is preferable to consider that each signal has a different sampling frequency and a different number of bits for digitization. The measure of quantization noise with respect to the sampling frequency is referred to in the sampling theorem, and according to this, a range below ½ (Nyquist frequency) of the sampling frequency may be used for F obtained by Fourier-transforming a signal f.

When the sampling frequencies of the two signals (first signal and second signal) for estimating the relation are different from each other, the range may be adjusted to the one in which the Nyquist frequency is lower (the transmission interval is longer).

Further, the quantization noise error by FFT in an integer or a fixed-point number generally used in a CAN signal can be estimated as in the following equation (1). In the equation (1), B is the number of bits, N is the number of sampling, and RMS is the mean square root.

$$\\ \begin{matrix}[ Math . 1 ] & \\ \frac{rms ( error )}{rms ( F )} \approx \frac{\sqrt{N} \cdot {2}^{- B} \cdot 0.3 \sqrt{8}}{rms ( f )} & ( 1 )\end{matrix}$$

Since the magnitude of the quantization noise can be regarded to be almost constant regardless of the frequency, only a range in which the power spectrum can be regarded to be sufficiently larger than the noise, that is, a range in which the power spectrum becomes a power spectrum of a certain specified value or more, can be used for estimation.

Then, the determination unit 12 first acquires the Nyquist frequency (½ of the sampling frequency) of each signal from the quantization condition, and sets a frequency band lower than the smaller Nyquist frequency as a candidate of a frequency band with less influence of quantization noise. Then, the determination unit 12 determines a frequency band in which the power spectrum is equal to or more than a specified value, as a candidate for each signal.

Then, the determination unit 12 determines (selects) a frequency band in which all the candidate frequency bands overlap, as a frequency band in which the influence of quantization noise is small. The determination unit 12 may determine a sufficiently large value, for example, with an rms (error) that can be estimated by the equation (5), as a reference, as the above-mentioned specified value (threshold). Further, the determination unit 12 may select the frequency of the peak value of the power spectrum depending on the signal collection method. In this case, when signal data is collected from the mobile body 1 when traveling around by an excellent driver, for example, signal values that repeat almost in the same way for each round are acquired. In this case, since the power spectrum becomes a sharp peak at a frequency of m (m is an integer)/round time and becomes a small value at other frequencies, it is preferred that only the peak value be selected.

Subsequently, the determination unit 12 determines a relevance between the first spectrum of the first signal and the second spectrum of the second signal in the frequency band (step S104). The determination unit 12 determines a relevance between the first signal and the second signal on the basis of a degree of linearity between a logarithm of a ratio of the first spectrum and the second spectrum to each frequency and a logarithm of the frequency. Thus, it is possible to analyze whether there is a differential relation derived from a physical law or the like between the two signals.

It should be noted that the control signals in the machines are affected by physical laws and external environmental factors, and many of them are correlated. For example, the signal value of the acceleration measuring sensor has a relationship obtained by differentiating the signal value of a speed notation function. In general, the correlation based on a physical law can be expressed by a differential equation. According to the present disclosure, processing such as Fourier transform is performed on each of the two signals, and it is determined whether there is correlation based on the physical law between the two signals.

The determination unit 12 determines the correlation between the function-identified first signal and the function-unidentified second signal. Therefore, not only signals of the same function can be found, but also related signals can be found by the physical law.

The principle of the present disclosure will be described by taking signals f(t) and g(t) having an n-th order differential relationship as shown by the following equation (2). It is assumed that a signal g has been amplified by a-fold for the reason of the specification of the ECU, and that there is a fixed delay d (or an advance −d) in transmission.

$$\\ \begin{matrix}[ Math . 2 ] & \\ g ( t ) = a \cdot \frac{{d}^{n}}{{dt}^{n}} f ( t + d ) & ( 2 )\end{matrix}$$

A function F(x) obtained by Fourier transform of the signal f(t) is expressed by the following equation (3). In the equation (3), t is time, x is frequency (x≥0), and i is an imaginary unit.

$$\\ \begin{matrix}[ Math . 3 ] & \\ F ( x ) = {\int }_{- ∞}^{+ ∞} {e}^{- 2 π ixt} f ( t ) dt & ( 3 )\end{matrix}$$

On the other hand, the function G(x) obtained by the Fourier transform of the signal g(t) is expressed by F(x) as in the following equation (4) from the equation (2) and the Fourier transform formula.

$$\\ \begin{matrix}[ Math . 4 ] & \\ \begin{matrix}G ( x ) = {\int }_{- ∞}^{+ ∞} {e}^{- 2 π ixt} g ( t ) dt \\ = {\int }_{- ∞}^{+ ∞} {e}^{- 2 π ixt} \cdot a \cdot \frac{{d}^{n}}{{dt}^{n}} f ( t + d ) dt = a \cdot {{e}^{2 π id} ( 2 π ix )}^{n} F ( x )\end{matrix} & ( 4 )\end{matrix}$$

Taking the norm of both sides of the equation (4) and organizing it as a relational expression for the power spectra |F| and |G|, the following equations (5), (6), and (7) are obtained.

$$\\ \begin{matrix}[ Math . 5 ] & \\ \vert G ( x ) \vert = \vert a \cdot {{e}^{2 π id} ( 2 π ix )}^{n} F ( x ) \vert & ( 5 )\end{matrix}$$

$$\\ \begin{matrix}[ Math . 6 ] & \\ \vert G ( x ) \vert = \vert a \vert {( 2 π x )}^{n} \vert F ( x ) \vert & ( 6 )\end{matrix}$$

$$\\ \begin{matrix}[ Math . 7 ] & \\ log \frac{\vert G ( x ) \vert}{\vert F ( x ) \vert} = n \cdot log 2 π x + log \vert a \vert & ( 7 )\end{matrix}$$

The equation (7) shows that the logarithm of the power spectrum ratio |G|/|F| and the logarithm of the angular frequency 2πx have a linear relationship and that the slope is the differential order n. In the case of a differential relation, the slope is positive; conversely, in the case of an integral relation, the slope is negative, and in the case of an isomorphic relation, the slope is horizontal.

Therefore, the determination unit 12 can determine the presence or absence of the relationship based on whether or not the logarithm of the power spectrum ratio and the logarithm of the angular frequency are in a linear relationship between the two signals. Further, the determination unit 12 can estimate the differential order n from the inclination. It also has the feature that the determination can be made by excluding the influence of the amplification a and the transmission delay d from the equation (7).

The actual signal in the CAN or the like is regarded as a sampling signal which periodically transmits a digital value, instead of the above-mentioned continuous function. As a method for Fourier-transforming such a sampling signal, a discrete Fourier transform (DFT) or a fast Fourier transform (FFT) which is a faster algorithm can be used.

In step S104, the determination unit 12 may determine whether the logarithm of the ratio of each power spectrum and the logarithm of the frequency have a linear relationship (or whether the linearity is equal to or higher than a threshold) in the selected frequency band according to the equation (7). In this case, the determination unit 12 may determine whether or not there is a linear relationship by using a least-squares method which approximates the logarithm of the ratio of the power spectrum and the logarithm of the frequency by a linear function. In this case, the determination unit 12 may determine that there is a linear relationship if a determination coefficient R² in the least-squares method is linear and the determination coefficient R² that is a real number of 0 or more and 1 or less is a value equal to or more than a threshold value (prescribed value). The determination coefficient R² in the least-squares method may be, for example, a value obtained by subtracting a square sum of the residuals divided by a square sum of a deviation from an average value of the sample values from 1.

Further, the determination unit 12 may estimate the differential order from the inclination of the approximated linear function, and estimate the logarithm of the amplification factor from the intercept.

In addition, the determination unit 12 may use the equation (3) instead of the equation (7). In this case, although the amount of calculation increases due to the handling of complex numbers, the determination can be similarly performed by the least-squares method or the like.

Subsequently, the output unit 13 outputs information indicating the relevance between the spectra of the first signal and the second signal determined by the determination unit 12 (step S105). Here, the output unit 13 may, for example, display numerical values indicating the relationship between the first and second signals (relevance), or a scatter diagram illustrating the linear relevance shown in the equation (7).

The output unit 13 may also display the above-mentioned differential order and amplification factor. Further, the output unit 13 may display a scatter diagram of the logarithm of the ratio of the power spectrum and the logarithm of the frequency and its approximate straight line in a graph.

<<Example of Using Correlation Analysis Between Three or More Signals>>

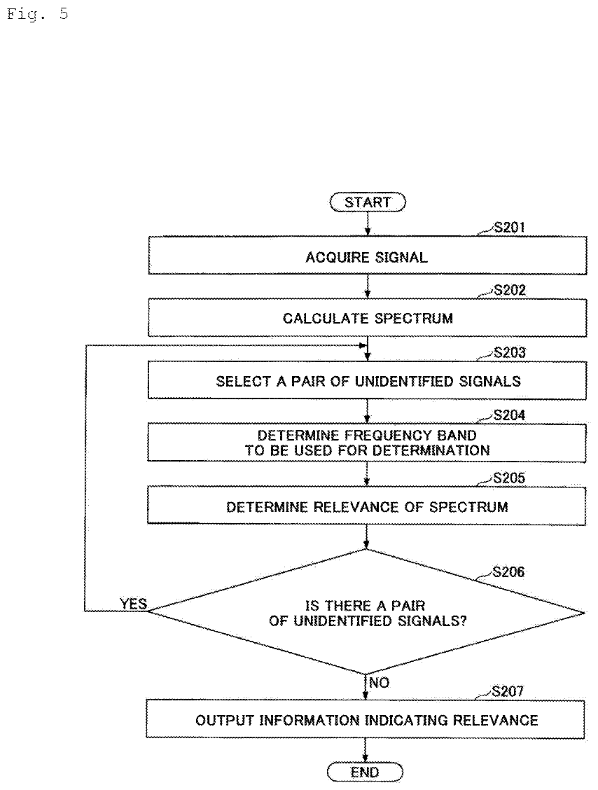

An example of processing of the information processing device 10 according to an embodiment will be described next with reference to FIG. 5. FIG. 5 is a flowchart for explaining an example of processing of the information processing device 10 according to an embodiment.

In step S201, the acquisition unit 11 acquires three or more signals. Here, the acquisition unit 11 acquires three or more signals in the same manner as the processing of step S101 shown in FIG. 4.

Subsequently, the determination unit 12 calculates each spectrum of the three or more signals acquired by the acquisition unit 11, respectively (step S202). Here, the determination unit 12 calculates the spectra for the three or more signals, respectively, in the same manner as in the processing of step S102 shown in FIG. 4. Here, the determination unit 12 calculates and stores the spectra of all the signals. Consequently, the calculation processing can be made efficient so that the spectrum calculation for the same signal is not repeated many times.

Subsequently, the determination unit 12 selects a pair of signals (the first signal and the second signal) whose relevance is not determined (step S203).

Subsequently, the determination unit 12 determines a frequency band in which the influence of quantization noise disturbing estimation of the relationship between the two signals is small, from each signal, a spectrum of each signal, and a quantization condition which is information on a sampling frequency and the number of bits of the signal, or the like. In this case, the determination unit 12 may determine a frequency band which is less affected by quantization noise, in the same manner as in the processing of step S103 shown in FIG. 4.

Subsequently, the determination unit 12 determines the relevance between the spectrum of the first signal and the spectrum of the second signal in the frequency band (step S205). Here, the determination unit 12 determines the relevance in the same manner as in the processing of the step S104 shown in FIG. 4

Then, the determination unit 12 determines whether there is a pair of signals whose relevance has not been determined (step S206). If there is a pair of signals whose relevance is not determined (YES in step S206), the processing proceeds to step S202.

On the other hand, if there is no pair of signals whose relevance is not determined (NO in step S206), the output unit 13 outputs information indicating the relevance between the spectra of the first signal and the second signal determined by the determination unit 12 (step S207). Here, the output unit 13 may display, for example, a numerical value indicating the relevance for each pair of signals, a cluster obtained by collecting related signals, and the like.

Further, the output unit 13 may display, for example, a cluster in which signals having high relevance are collected. Further, the output unit 13 may display, for example, a result of further classifying the signals in the cluster by the differential order. In this case, for example, the output unit 13 has three signals determined to be correlated with the speed display signal, and the differential order of each signal may be displayed as 1, −1, and 0. This can assist, for example, in estimating that the three signals in question are acceleration, distance traveled, and speed (average speed), respectively.

Thus, it is easy to estimate a function associated with the related signals by dividing the signals into groups.

<<Example of Using Correlation Analysis of Communication Recording>>

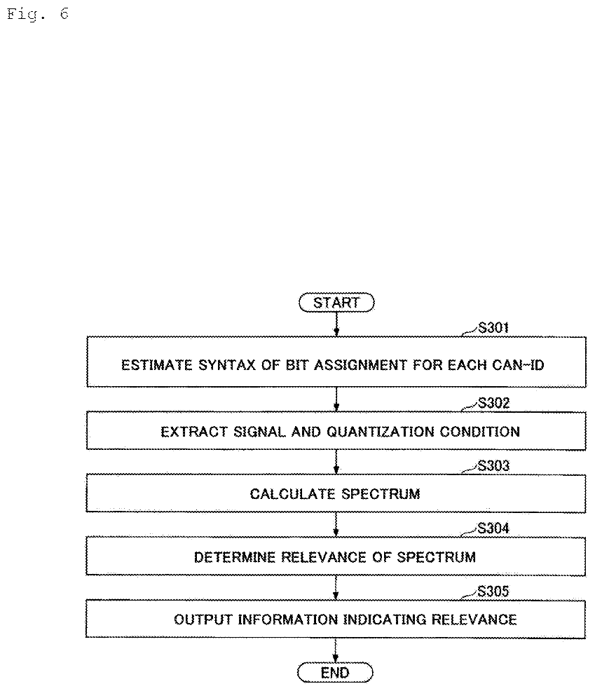

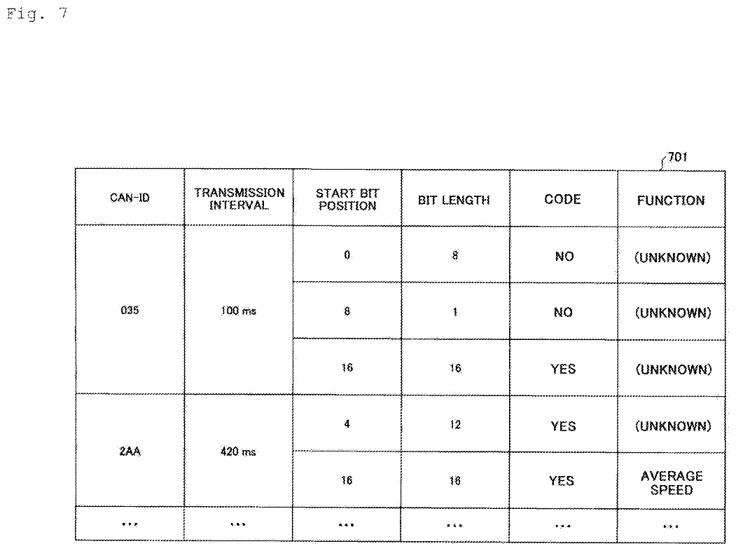

An example of processing of the information processing device 10 according to an embodiment will be described with reference to FIGS. 6 to 7. FIG. 6 is a flowchart for explaining an example of processing of the information processing device 10 according to an embodiment. FIG. 7 is a diagram showing an example of information indicating a syntax of bit assignment of CAN communication according to an embodiment.

The information processing device 10 may execute the above-mentioned processing shown in FIGS. 4 and 5 and the following processes shown in FIG. 6 in an appropriate combination. In this case, the information processing device 10 may output both the processing results shown in FIGS. 4 and 5 and the processing result shown in FIG. 6, for example. For example, the information processing device 10 may output information indicating that there is a relationship when the sum of the relevance values from the processing results shown in FIGS. 4 and 5 and the relevance value from the processing result shown in FIG. 6 is greater than a threshold value.

In step S301, the acquisition unit 11 acquires (estimates) a syntax of bit assignment of CAN communication shown in FIG. 7, from a record of CAN communication (CAN communication history). In this case, the CAN communication history is a record of messages containing CAN-IDs collected over a certain period of time. A CAN-ID is identification information of a type of a communication message in the CAN.

The acquisition unit 11 can use a method such as partitioning bit strings arranged in order from small change to large change (or large change to small change), as a signal. In this case, the acquisition unit 11 may perform differential transformations on the signals to be estimated whether they are signed or unsigned, respectively, and obtain the variance of the transformed signals. The acquisition unit 11 may determine that the code is correctly estimated when the variance is smaller.

In the example shown in FIG. 7, information 701 indicating a syntax of bit assignment of CAN communication includes items such as a CAN-ID, a transmission interval, a start bit position, a bit length, a code, and a function. Here, the item of function is an item of information which cannot be obtained by syntax estimation, but it can be determined in advance for which known bit assignment information is obtained.

Subsequently, the acquisition unit 11 acquires (extracts) a signal and a quantization condition from the CAN communication history on the basis of the syntax of the bit assignment (step S302). Here, the acquisition unit 11 may use the transmission interval and bit length of the bit assignment as quantization conditions.

The CAN communication history used for estimating the syntax in the processing of step S301 and the CAN communication history which is a source of extracting the signal in the processing of step S302 may be different. In this case, for example, different time zones, different operations, and a CAN communication history of another mobile body of the same model may be used.

Subsequently, the determination unit 12 calculates spectra of the function-identified first signal and the functional-unidentified second signal, which are acquired by the acquisition unit 11, respectively (step S303). Subsequently, the determination unit 12 determines the relevance between the spectra of the first signal and the second signal (step S304). Subsequently, the output unit 13 outputs information indicating the relevance between the spectra of the first signal and the second signal that is determined by the determination unit 12 (step S305). The processing steps of steps S303 to S305 shown in FIG. 6 may be the same as the processing steps of steps S102, S104, and S105 shown in FIG. 4. Thus, for example, in CAN communication, a series of syntax estimation and semantic estimation of bit assignment can be analyzed. In the semantic estimation, since the relation between signals based on the physical law such as the differential relation can be determined, it is easy to estimate the functions of more signals.

The determination unit 12 may add the determination result obtained in step S304 as a known bit assignment, and repeat processing subsequent to step S303.

(Example of Detecting Abnormality by Utilizing Signal Relevance (Relationship))

The determination unit 12 may detect abnormality by utilizing the relevance (relationship) between signals. In this case, the determination unit 12 stores a first CAN-ID of the first signal whose relevance is equal to or more than a threshold and a second CAN-ID of the second signal, in association with each other.

Then, the determination unit 12 determines again the relevance at predetermined timing such as a regular period, for the communication message of each signal whose relevance is equal to or more than the threshold. When the relevance between a third signal of the communication message of the first CAN-ID and a fourth signal of the communication message of the second CAN-ID is less than the threshold, the determination unit 12 causes the output unit 13 to output a warning indicating that an abnormality has occurred in at least either one of the communication message of the first CAN-ID and the communication message of the second CAN-ID.

Thus, for example, it is possible to detect that the signal is altered by a cyber attack. In the conventional abnormality detection method, although insertion of an attack message can be detected, it is difficult to detect an attack in which message contents are altered without insertion. According to the present disclosure, abnormality detection can be performed even when a message is altered.

The determination unit 12 may, for example, re-determine the relevance for each signal whose relevance is equal to or above the threshold when a discrepancy is detected in the acceleration sensor signal that indicates that the speed was not particularly accelerated when the speed indication signal was altered as if the speed was suddenly increased.

The determination unit 12 may also re-determine the relevance for each combination of two signals among three or more signals whose relevances are mutually equal to or more than a threshold, and when the relevances are less than the threshold, the determination unit 12 may determine that abnormality occurs in at least one of the signals.

### MODIFIED EXAMPLES

At least a part of each function unit of the information processing device 10 may be realized by cloud computing or the like provided by one or more computers, for example. Further, the determination unit 12 or the like may be provided in a server 50 outside the mobile body 1.

<Advantageous Effects of Present Invention>

According to the technique of the present disclosure described above, signals communicated by a CAN or the like used for control communication of machines are converted into spectra by Fourier transform or the like, and correlation between the spectra is determined, so that signals related to physical laws such as differential relationship can be determined.

Therefore, for example, in the estimation of the function associated with the signal required for analyzing a cyber attack (semantic estimation of bit assignment), the relation between the signals based on the physical laws such as the differential relation can be efficiently found, and the function can be estimated for more signals.

Although embodiments of the present invention have been described above in detail, the present invention is not limited to these particular embodiments, and various types of modifications and changes may be made within the scope of the gist of the present invention set forth in claims.

### REFERENCE SIGNS LIST

1 Mobile body
10 Information processing device
11 Acquisition unit
12 Determining unit
13 Output unit
50 Server

1. A mobile body comprising:
an apparatus; and
an information processing device,
wherein the information processing device includes
a memory, and
a processor coupled to the memory and configured to:
acquire a first signal and a second signal that are transmitted from the apparatus; and
determine a relevance between the first signal and the second signal on the basis of a first spectrum of a frequency component of the first signal and a second spectrum of a frequency component of the second signal.

2. The mobile body according to claim 1, wherein the processor is configured to determine the relevance between the first signal and the second signal on the basis of a degree of linearity between a logarithm of a ratio of the first spectrum and the second spectrum to each frequency and a logarithm of a frequency.

3. The mobile body according to claim 1, wherein the processor is configured to store a first communication message ID of the first signal and a second communication message ID of the second signal, with the relevance therebetween being equal to or greater than a threshold, and output a warning when a relevance between a third signal of a communication message including the first communication message ID and a fourth signal of a communication message including the second communication message ID is less than the threshold.

4. An information processing device comprising:
a memory; and
a processor coupled to the memory and configured to
acquire a first signal and a second signal that are transmitted from an apparatus; and
determine a relevance between the first signal and the second signal on the basis of a first spectrum of a frequency component of the first signal and a second spectrum of a frequency component of the second signal.

5. An information processing method performed by an information processing device, the information processing method comprising:
acquiring a first signal and a second signal that are transmitted from an apparatus; and
determining a relevance between the first signal and the second signal on the basis of a first spectrum of a frequency component of the first signal and a second spectrum of a frequency component of the second signal.

6. A non-transitory computer-readable recording medium storing a program for causing an information processing device to perform the information processing method according to claim 5.
